(19) United States
(12) Patent Application Publication
(10) Pub. No.: US 2005/0278404 A1
(43) Pub. Date: Dec. 15, 2005

(54) Method and apparatus for single iteration fast Fourier transform

(75) Inventor: Marwan Jaber, Montreal (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: Jaber Associates, L.L.C., Wilmington, DE (US)

(21) Appl. No.: 11/096,826

(22) Filed: Apr. 1, 2005

Related U.S. Application Data
(60) Provisional application No. 60/559,869, filed on Apr. 5, 2004.

(51) Int. Cl. G06F 15/00

(52) U.S. Cl. 708/404

(57) ABSTRACT

The present invention is single-iteration Fourier transform processor. A Fourier transform processor performs Fourier transform of N input data into N output data with a radix-r butterfly. The Fourier transform processor includes N/r radix-r modules. Each radix-r module includes a plurality of radix-r engines, and each radix-r engine includes a plurality of multipliers for multiplying each of the data inputs and corresponding coefficients, an adder for adding the multiplication results and an accumulator for accumulating the multiplication results to generate a Fourier transform output. By accumulating the processing results instead storing intermediate results, the present invention reduces memory access times. More than one radix-r engines may be utilized in parallel to generate one output, or N radix-r engines may be used in maximum parallel processing.

### CROSS REFERENCE TO RELATED APPLICATION

This application claims the benefit of U.S. Provisional Application No. 60/559,869, filed Apr. 5, 2004, which is incorporated by reference as if fully set forth.

### FIELD OF INVENTION

The present invention is related to Fourier transforms. More particularly, the present invention is single-iteration Fourier transform processor.

### BACKGROUND

A signal may be represented in the time domain as a variable that changes with time. In the time domain, a sampled data digital signal is a series of data points corresponding to the original physical parameter. Alternatively, a signal may be represented in the frequency domain as energy at specific frequencies. In the frequency domain, a sampled data digital signal is represented in the form of a plurality of discrete frequency components such as sine waves. A sampled data signal is transformed from the time domain to the frequency domain using a Discrete Fourier Transform (DFT). Conversely, a sampled data signal is transformed back from the frequency domain into the time domain using an Inverse Discrete Fourier Transform (IDFT).

8 Although most signals are sampled and processed in the time domain, frequency analysis provides spectral information about signals that are further examined or used in further processing. For example, frequency domain processing allows for the efficient computation of the convolution integral useful in linear filtering and for signal correlation analysis. The DFT and the IDFT are fundamental digital signal processing transformations used in many applications since they permit a signal to be processed in different domains. However, since the direct computation of the DFT requires a large number of arithmetic operations, the direct computation of the DFT is typically not used in real time applications.

Computation burden is a measure of the number of calculations required by an algorithm. The DFT process starts with a number of input data points and computes a number of output data points. For example, an 8-point DFT may have an 8-point output. The DFT function is a sum of products, i.e., multiplications to form product terms followed by the addition of product terms to accumulate a sum of products (multiply-accumulate, or MAC operations). The direct computation of the DFT requires a large number of such multiply-accumulate mathematical operations, especially as the number of input points is larger. Multiplications by the twiddle factors W_{N}^{r} dominate the arithmetic workload.

Over the past few decades, a group of algorithms collectively known as Fast Fourier Transforms (FFTs) have found use in diverse applications, such as digital filtering, audio processing and spectral analysis for speech recognition. The FFT reduces computational burden so that it may be used for real-time signal processing.

To reduce the computational burden imposed by the computationally intensive DFT, the FFT algorithms were developed to reduce the number of required mathematical operations is reduced. In an FFT, the input data are divided in subsets for which partial DFTs are computed. The DFT of the initial data is then reconstructed from the partial DFTs. There are two approaches to dividing, (also called decimating), the larger calculation task into smaller calculation sub-tasks: decimation in frequency (DIF) and decimation in time (DIT).

For example, an 8-point DFT is divided into 2-point partial DFTs. The basic 2-point partial DFT is calculated in a computational element called a radix-2 butterfly as shown in FIGS. 1(A) and 1(B). A radix-2 butterfly has 2 inputs and 2 outputs, and computes a 2-point DFT. Higher order butterflies may be used. In general, a radix-r butterfly is a computing element that has r input points and calculates a partial DFT of r output points.

A computational problem involving a large number of calculations may be performed one calculation at a time by using a single computing element. While such a solution uses a minimum of hardware, the time required to complete the calculation may be excessive. To speed up the calculation, a number of computing elements may be used in parallel to perform all or some of the calculations simultaneously. A massively parallel computation tends to require an excessively large number of parallel computing elements. Even so, parallel computation is limited by the communication burden. The communication burden of an algorithm is a measure of the amount of data that must be moved, and the number of calculations that must be performed in sequence (i.e., that cannot be performed in parallel). For example, a large number of data and constants may have to be retrieved from memory over a finite capacity data bus. In addition, intermediate results from one stage may have to be completed before beginning a later stage calculation.

In particular, in an FFT butterfly implementation of the DFT, some of the butterfly calculations cannot be performed simultaneously, (i.e., in parallel). Subsequent stages of butterflies cannot begin calculations until earlier stages of butterflies have completed prior calculations. The communication burden between stages of the butterfly calculation cannot therefore be reduced through the use of parallel computation. While the FFT has a smaller computational burden as compared to the direct computation of the DFT, the butterfly implementation of the FFT has a greater communication burden.

Within the butterfly-computing element itself (i.e., within the radix-r butterfly), there are similar considerations of computational burden versus communication burden. That is, within the radix-r butterfly-computing element itself, not all the required calculations can be performed simultaneously by parallel computing elements. Intermediate results from one calculation are often required for a later computation. Thus, while the FFT butterfly implementation of the DFT reduces the computational burden, it does not decrease the communication burden.

Using a higher radix butterfly can reduce the communication burden. For example, a 16-point DFT may be computed in two stages of radix-4 butterflies, as compared to three stages of radix-2 butterflies. Higher radix FFT algorithms are attractive for hardware implementation because of the reduced net number of complex multiplications (including trivial ones) and the reduced number of stages, which reduces the memory access rate requirement. The number of stages corresponds to the amount of global communication and/or memory accesses in an implementation. Thus, reducing the number of stages reduces the communication burden.

However, higher order radix-r butterflies are not typically used, even though such butterflies will have a smaller net number of complex multiplications and such higher radix butterflies reduce the communication load. The reason is that the complexity of the radix-r butterfly increases rapidly for higher radices. As a result, the vast majority of FFT processor implementations have used the radix-2 or radix-4 versions of the FFT algorithm.

### SUMMARY

The present invention is related to a single-iteration Fourier transform processor. A Fourier transform processor performs Fourier transform of N input data into N output data with radix-r butterfly. The Fourier transform processor includes N/r radix-r modules. Each radix-r module includes a plurality of radix-r engines, and each radix-r engine includes a plurality of multipliers for multiplying each of the input data and corresponding coefficients, an adder for adding the multiplication results and an accumulator for accumulating the multiplication results to generate one Fourier transform output. By accumulating the processing results instead storing intermediate results, the present invention reduces memory access times. More than one radix-r engines may be utilized in parallel to generate one output or N radix-r engines may be used in maximum parallel processing.

### BRIEF DESCRIPTION OF THE DRAWINGS

FIGS. 1(a) and 1(b) show prior art radix-2 DIF and DIT butterflies.

FIGS. 2(a) and 2(b) show radix-r DIF engine and simplified representation of the same in accordance with the present invention.

FIGS. 3(a) and 3(b) show radix-r DIT engine and simplified representation of the same in accordance with the present invention.

FIGS. 4(a) and 4(b) show radix-r DIT module DIF module in accordance with the present invention.

FIG. 5 is a radix-r one iteration kernel computation engine in accordance with the present invention.

FIG. 6 is an alternative representation of FIG. 5.

FIG. 7 is a radix-r one iteration module in accordance with the present invention.

FIG. 8 is an embodiment in which the degree of parallelism is increased.

FIGS. 9(a) and 9(b) is a basic radix-2 one iteration FFT engine core and an alternative representation of the same in accordance with the present invention.

FIG. 10 is a radix-2 one iteration FFT engine in accordance with the present invention.

FIG. 11 is a radix-2 one iteration FFT module in accordance with the present invention.

FIG. 12 is a parallel implementation of the radix-2 one iteration FFT module in accordance with the present invention.

FIG. 13 is a maximum parallel implementation of the radix-2 one iteration for 8-point FFT in accordance with the present invention.

FIG. 14 is a radix-r one iteration FFT engine with increased parallelism in accordance with the present invention.

FIG. 15 is a radix-2 one iteration FFT engine in accordance with the present invention.

FIG. 16 represents an alternative representation of the radix-2 one iteration FFT engine of FIG. 15.

FIG. 17 is a radix-2 one iteration FFT module in accordance with the present invention.

FIG. 18 is a radix-r one iteration FFT module with increased parallelism in accordance with the present invention.

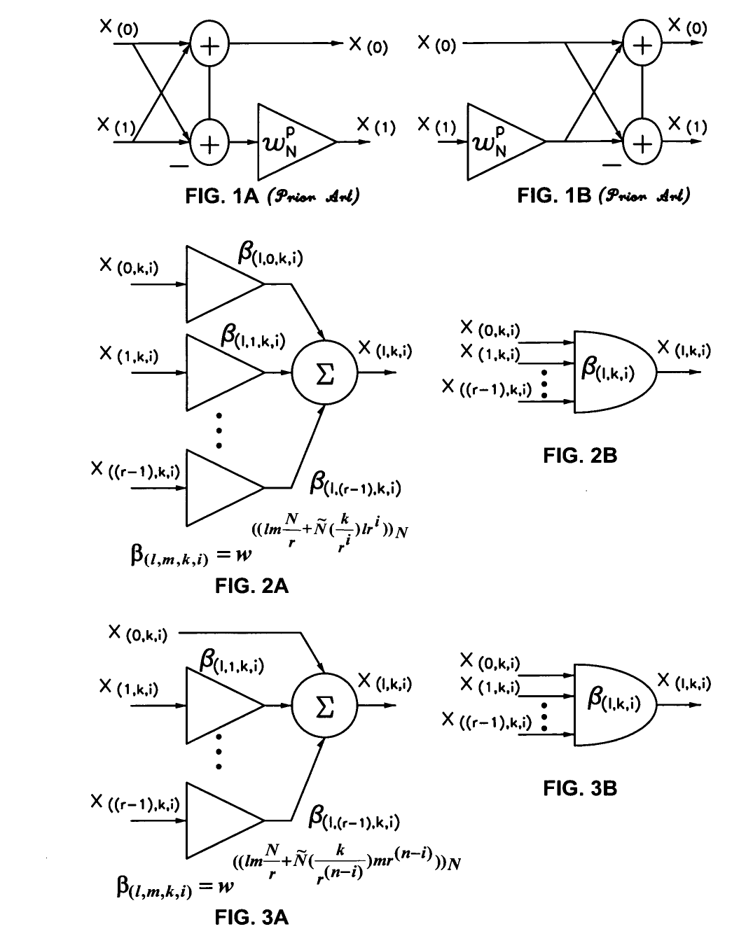

### DETAILED DESCRIPTION OF THE PREFERRED EMBODIMENTS

The present invention provides an optimum architecture of an FFT processor that reduces the computational and the communicational burden, (as measured by the number of multiplications and memory accesses), to the r^{ith} of the effort required by the most radix-r FFT processors. The advantage of using a higher radix, (i.e. higher value of r), is that the number of multiplications and the number of stages decrease. The number of stages often corresponds to the amount of global communication and/or memory accesses in implementation and thus, the reduction in the number of stages is beneficial if communication is expensive as is the case in most hardware implementations.

The FFT process is an operation that could be performed through different stages. In each stage, the only operation that occurs is the butterfly computation in which the accessed data is multiplied by certain w^{α} and then added or subtracted, and finally stored or held for further processing. In the next stage, the processed data is accessed, multiplied by certain w^{β} and then added or subtracted, and finally stored or held for further processing till the final stage where the processed data is driven to the output. Therefore, by finding an appropriate indexing or mapping scheme between the input data and the coefficient multipliers throughout the different stages, a single stage of computation can be yielded in which those different stages collapse into a single stage of computation.

For a specific input xᵢ, by predicting that it will be multiplied by w^{α} in the first stage, by w^{β} in the second stage and so on; this whole process can be replaced by w^{α+β+. . .} .

The definition of the DFT is shown in equation (1), where x₍ₙ₎ is the input sequence, X₍ₖ₎ is the output sequence, N is the transform length and w_{N} is the N^{th} root of unity (w_{N}=e^{-j2π/N}). Both x₍ₙ₎ and X₍ₖ₎ are complex valued sequences.

$${X}_{( k )} = {\sum }_{n = 0}^{n = N - 1} {x}_{( n )} {w}_{N}^{nk} , k ∈ [ 0 , N - 1 ] ; \qquad ( Equation 1 )$$

The basic operation of a radix-r PE is the so-called butterfly in which r inputs are combined to give the r outputs via the operation:
X=Bᵣ×x; (Equation 2)
where x=[x₍₀₎, x₍₁₎, . . . , x₍ᵣ₋₁₎]^{T} is the input vector and X=[X₍₀₎, X₍₁₎, . . . , X₍ᵣ₋₁₎]^{T} is the output vector. Bᵣ is the r×r butterfly matrix, which can be expressed as:
Bᵣ=W_{N}^{r}×Tᵣ; (Equation 3)
for the decimation in frequency process, and:
Bᵣ=Tᵣ×W_{N}^{r}; (Equation 4)
for the decimation in time process.
W_{N}^{r}=diag(1, w_{N}^{P}, w_{N}^{2p}, . . . , w_{N}^{(r-1)p}); (Equation 5)
represents the diagonal matrix of the twiddle factor multipliers and Tᵣ is an r×r matrix representing the adder-tree in the butterfly, where:

$${T}_{r} = [ \begin{matrix}{w}^{0} & {w}^{0} & {w}^{0} & - & {w}^{0} \\ {w}^{0} & {w}^{N / r} & {w}^{2 N / r} & - & {w}^{( r - 1 ) N / r} \\ {w}^{0} & {w}^{2 N / r} & {w}^{4 N / r} & - & {w}^{2 ( r - 1 ) N / r} \\ - & - & - & - & - \\ {w}^{0} & {w}^{( r - 1 ) N / r} & - & - & {w}^{{( r - 1 )}^{2} N / r}\end{matrix} ] = [ {T}_{( l , m )} ] ; \qquad ( Equation 6 )$$

where

$${T}_{( l , m )} = {w}^{{( ( l \times m \times ( \frac{N}{r} ) ) )}_{N}} ; \qquad ( Equation 7 )$$

and l=m=0, . . . , r−1 and ((x))_{N=x} modulo N.

As seen from equations (3) and (4) that the adder tree Tr is identical for the two algorithms. The only difference is the order in which the twiddle-factor and the adder tree multiplication is computed. A straightforward implementation of the adder-tree does not need be effective for higher radices butterflies due to the increasing complexity of the hardware implementation of higher radices butterflies. However, since both the elements of the adder tree matrix Tᵣ and the twiddle factor matrix W_{N}^{r} contain twiddle factors, by controlling the variation of the twiddle factor during the calculation of a complete FFT, the twiddle factors and the adder tree matrices can be incorporated into a single stage of calculation. This is the mathematical principle of the present invention that will be described in detail hereinafter.

The Jaber radix-r Butterfly Structure

According to Equation (4), Bᵣ is the product of the twiddle factor matrix W_{N}^{r} and the adder tree matrix Tᵣ. So, by defining W_{(r,k,i)} the set of the twiddle factor matrices W_{N}^{r} as:

$${W}_{( r , k , i )} = [ \begin{matrix}{w}_{( 0 , k , i )} & 0 & - & 0 \\ 0 & {w}_{( 1 , k , i )} & - & 0 \\ - & & & - \\ 0 & 0 & - & {w}_{( ( r - 1 ) , k , i )}\end{matrix} ] ; \qquad ( Equation 8 )$$

in which;

$${w}_{{( l , m )}_{( k , i )}} = {w}^{{( ( \tilde{N} ( \frac{k}{{r}^{i}} ) \times l \times {r}^{i} ) )}_{N}}$$

for l=m, and 0 elsewhere; (Equation 9)
the modified radix-r butterfly computation Br DIF (Equation 4) may be expressed as:
B_{r DIF}=W_{(r,k,i)}×Tᵣ=[B_{r DIF (l,m)}_{_{(k,i)}}]; (Equation 10)
with;

$${B}_{{rDIF ( l , m )}_{( k , i )}} = {w}^{{( ( \tilde{N} ( \frac{k}{{r}^{i}} ) \times l \times {r}^{i} ) )}_{N}} ; \qquad ( Equation 11 )$$

for l=m=0, . . . , r−1, i=0,1 . . . , n−1 and k=0,1 . . . , (N/r)−1, where ((x))_{N} denotes x modulo N and Ñ(k/rⁱ) is defined as the integer part of the division of k by rⁱ.

As a result, the operation of a radix-r PE for the DIF FFT can be formulated as a column vector:
X_{(r,k,i)}=B_{r DIF}×x=[X₍ₗ₎_{_{(k,i)}}]; (Equation 12)
whose l^{th} element is given by:

$${X}_{{( l )}_{( k , i )}} = {\sum }_{m = 0}^{r - 1} {x}_{( m )} {w}^{{( ( l \times m \times ( \frac{N}{r} ) + \tilde{N} ( \frac{k}{{r}^{i}} ) \times l \times {r}^{i} ) )}_{N}} . \qquad ( Equation 13 )$$

With the same reasoning as above, the operation of a radix-r DIT FFT can be derived. In fact, according to Equation (3), Br is the product of the adder matrix Tr and the twiddle factor matrix W_{N}^{r}, which is equal to:
B_{r DIT}=Tᵣ×W_{(r,k,i)}=[B_{r DIT(l,m)}_{_{(k,i)}}]; (Equation 14)
in which;

$$\begin{matrix}{B}_{{rDIT ( l , m )}_{( k , i )}} = {w}^{{( ( l \times m \times ( \frac{N}{r} ) + \tilde{N} ( \frac{k}{{r}^{( n - i )}} ) \times m \times {r}^{( n - i )} ) )}_{N}} ; \\ and ; & ( Equation 15 ) \\ {W}_{( r , k , i )} = [ \begin{matrix}{w}_{( 0 , k , i )} & 0 & - & 0 \\ 0 & {w}_{( 1 , k , i )} & - & 0 \\ - & - & - & - \\ 0 & 0 & - & {w}_{( ( r - 1 ) , k , i )}\end{matrix} ] = [ {w}_{{( l , m )}_{( k , i )}} ] ; & ( Equation 16 )\end{matrix}$$

where;

$${w}_{{( l , m )}_{( k , i )}} = {w}^{{( ( \tilde{N} ( \frac{k}{{r}^{( n - i )}} ) \times m \times {r}^{( n - i )} ) )}_{N}} \\ for l = m , and 0 elsewhere ; \qquad ( Equation 17 )$$

i=0, 1, . . . ,n and n=(logᵣ N)−1.

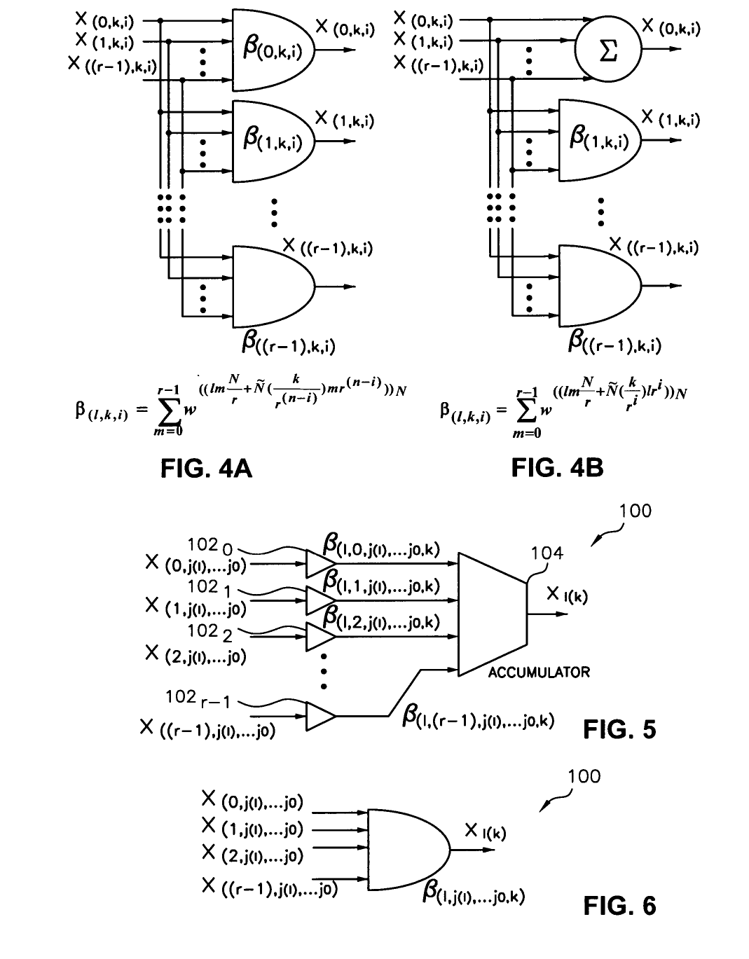

This formulation yields a pure parallel structure in which the computational load has been distributed evenly on r or r−1 parallel computing unit mainly composed of adders and multipliers and the delay factor has been totally eliminated. FIGS. 2(a) and 2(b) show a radix-r DIF engine and a simplified representation of the same respectively, and FIGS. 3(a) and 3(b) show a radix-r DIT engine and a simplified representation of the same, respectively. FIGS. 4(a) and 4(b) show a radix-r DIT module DIF module, respectively.

The present invention provides a structure of the one iteration algorithm for the dedicated FFT. The present invention reduces the communication load, reduces the computation load and particularly reduces the number of multiplications. The advantage of appropriately breaking the DFT in terms of its partial DFTs is that the number of multiplications and the number of stages may be controlled. The number of stages often corresponds to the amount of global communication and/or memory accesses in implementation. Thus, reduction in the number of stages is extremely beneficial.

Minimizing the computational complexity may be done at the algorithmic level of the design process, where the minimization of operations depends on the number representation in the implementation. Minimizing the communication load is achieved on the architecture level, where issues such as possibility to power down despite the Cooley-Tukey's clear definition stating that the DFT is a combination of its partial DFTs, researchers used to express the DFT in terms of its partial DFTs as:

$${X}_{( k )} = {\sum }_{n = 0}^{\frac{N}{r} - 1} {x}_{( rn )} {w}^{rnk} + … + {\sum }_{n = 0}^{\frac{N}{r} - 1} {x}_{( rn + ( r - 1 ) )} {w}^{( rn + ( r - 1 ) ) k} \qquad ( Equation 18 )$$

There is no need to prove that the DFT is not a linear combination of its partial DFTs. As a result, Equation (18) is mathematically incorrect because the sum of vectors of length N/r is not equal to a vector of length N. As a result the mathematical representation of the DFT into its partial DFTs is not yet well defined. The problem resides in finding the mathematical model of the combination phase, in which the concept of butterfly computation should be well structured in order to obtain an accurate mathematical model.

Jaber Product (\hat{*}^{(α,γ,β)})

For a given r×r square matrix Tᵣ and for a given column vector x₍ₙ₎ of size N, the Jaber product is defined expressed with the operator \hat{*}_{(α,γ,β)}, (Jaber product of radix α performed on γ column vector of size β), by the following operation where the γ column vectors are subsets of x₍ₙ₎ picked up at a stride α:

$$\begin{matrix}{X}_{( k )} = \hat{*} {}_{( r , r , N / r )} ( {T}_{r} , [ \begin{matrix}{x}_{( rn )} \\ {x}_{( rn + 1 )} \\ ⋮ \\ {x}_{( rn + ( r - 1 ) )}\end{matrix} ] ) = {T}_{r} \times [ \begin{matrix}{x}_{( rn )} \\ {x}_{( rn + 1 )} \\ ⋮ \\ {x}_{( rn + ( r - 1 ) )}\end{matrix} ] ; & ( Equation 19 ) \\ = [ \begin{matrix}{T}_{0 , 0} & {T}_{0 , 1} & ⋯ & {T}_{0 , ( r - 1 )} \\ {T}_{1 , 0} & {T}_{1 , 1} & ⋯ & {T}_{1 , ( r - 1 )} \\ ⋮ & ⋮ & ⋯ & ⋮ \\ {T}_{( r - 1 ) , 0} & {T}_{( r - 1 ) , 1} & ⋯ & {T}_{( r - 1 ) , ( r - 1 )}\end{matrix} ] \times col [ {x}_{( rn + {j}_{0} )} ] ; & ( Equation 20 ) \\ = [ {\sum }_{{j}_{0} = 0}^{r - 1} {T}_{( t , {j}_{0} )} {x}_{( rn + {j}_{0} )} ] \\ for k = 0 , 1 , … , ( \frac{N}{r} ) - 1 and l = 0 , 1 , … , r - 1 ; & ( Equation 21 )\end{matrix}$$

is a column vector or r column vectors of length (λ×β) where λ is a power of r in which the l^{th} element Yₗ of the k^{th} product Y_{(l,k)}is labeled as:
l₍ₖ₎=j₀×(λ×β)+k; (Equation 22)
for k=0,1, . . . , (λ×β)−1.

Properties of Jaber product.

Lemma 1
X₍ₖ₎=\hat{*}_{(r,rβ)}(Tₜ, (Wᵣ×col[x₍ᵣₙ₊ⱼ_{₀}₎]))=\hat{*}_{(r,rβ)}(Tᵣ×Wᵣ, (col[x₍ᵣₙ₊ⱼ_{₀}₎])). (Equation 23)
Proof:

$${X}_{( k )} = {\hat{*}}_{( r , r , β )} ( Tr , ( {W}_{r} \times col [ {x}_{( rn + {j}_{0} )} ] ) ) \\ = {T}_{r} \times ( {W}_{r} \times col [ {x}_{( rn + {j}_{0} )} ] ) \\ = ( {T}_{r} \times {W}_{r} ) \times col [ {x}_{( rn + {j}_{0} )} ] \\ = {\hat{*}}_{( r , r , β )} ( ( Tr \times {W}_{r} ) , ( col [ {x}_{( rn + {j}_{0} )} ] ) ) . \qquad ( Equation 24 )$$

Lemma 2

$$\begin{matrix}{X}_{( k )} = {{*}^{⋒}}_{( {r}_{0} , {r}_{0} , {k}_{0} )} ( {T}_{{r}_{0} ,} col [ \begin{matrix}{\hat{*}}_{( {r}_{1} , {r}_{1} , {k}_{1} )} ( {T}_{{r}_{1} ,} col [ {\sum }_{n = 0}^{( \frac{N}{{r}_{0} {r}_{1}} ) - 1} {x}_{( {r}_{0} ( {r}_{1} n + {j}_{1} ) )} ] ) \\ {\hat{*}}_{( {r}_{1} , {r}_{1} , {k}_{1} )} ( {T}_{{r}_{1} ,} col [ {\sum }_{n = 0}^{( \frac{N}{{r}_{0} {r}_{1}} ) - 1} {x}_{( {r}_{0} ( {r}_{1} n + {j}_{1} ) + ( {r}_{0} - 1 ) )} ] )\end{matrix} ] ) \\ = {{*}^{⋒}}_{( {r}_{0} , {r}_{0} , {k}_{0} )} ( {T}_{{r}_{0} ,} col [ {{*}^{⋒}}_{( {r}_{1} , {r}_{0} {r}_{1} , {k}_{1} )} ( {T}_{{r}_{1} ,} col [ {\sum }_{n = 0}^{( \frac{N}{{r}_{0} {r}_{1}} ) - 1} {x}_{( {r}_{0} ( {r}_{1} n + {j}_{1} ) + {j}_{0} )} ] ) ] ) .\end{matrix} \qquad ( Equation 25 )$$

Based on the previous section, Equation (1) for the first factorization can be rewritten as:

$${X}_{( k )} = {\sum }_{n = 0}^{N - 1} {x}_{( n )} {w}_{N}^{kn} \\ = {{*}^{⋒}}_{( r , r , N / r )} ( {T}_{r} , [ \begin{matrix}{\sum }_{n = 0}^{( N / r ) - 1} {x}_{( rn )} {w}_{N}^{{rnk}_{0}} \\ {\sum }_{n = 0}^{( N / r ) - 1} {x}_{( rn + 1 )} {w}_{N}^{( rn + 1 ) {k}_{0}} \\ ⋮ \\ {\sum }_{n = 0}^{( N / r ) - 1} {x}_{( rn + ( r - 1 ) )} {w}_{N}^{( rn + ( r - 1 ) ) {k}_{0}}\end{matrix} ] ) ; \qquad ( Equation 26 )$$

for k₀=0, 1, . . . , (N/r)−1, and n=0, 1, . . . , N−1.

Since:

$${w}_{N}^{rnk} = {w}_{N / r}^{nk} ; \qquad ( Equation 27 )$$

Equation (26) becomes:

$${X}_{( k )} = {{*}^{⋒}}_{( r , r , N / r )} ( {T}_{r} , [ \begin{matrix}{\sum }_{n = 0}^{( N / r ) - 1} {x}_{( rn )} {w}_{N / r}^{{nk}_{0}} \\ {w}_{N}^{{k}_{0}} {\sum }_{n = 0}^{( N / r ) - 1} {x}_{( rn + 1 )} {w}_{N / r}^{{nk}_{0}} \\ ⋮ \\ {w}_{N}^{( r - 1 ) {k}_{0}} {\sum }_{n = 0}^{( N / r ) - 1} {x}_{( rn + ( r - 1 ) )} {w}_{N / r}^{{nk}_{0}}\end{matrix} ] ) ; \qquad ( Equation 28 )$$

which for simplicity may be expressed as:

$${X}_{( k )} = {{*}^{⋒}}_{( r , r , N / r )} ( {T}_{r} \times [ {w}_{N}^{{j}_{0} {k}_{1}} ] , col [ {\sum }_{n = 0}^{( N / r ) - 1} {x}_{( rn + ( r - 1 ) )} {w}_{N / r}^{{nk}_{0}} ] ) ; \qquad ( Equation 29 )$$

where for simplification in notation the column vector in Equation (29) is set equal to:

$$[ \begin{matrix}{\sum }_{n = 0}^{( N / r ) - 1} {x}_{( rn )} {w}_{N / r}^{{nk}_{0}} \\ {w}_{N}^{{k}_{0}} {\sum }_{n = 0}^{( N / r ) - 1} {x}_{( rn + 1 )} {w}_{N / r}^{{nk}_{0}} \\ ⋮ \\ {w}_{N}^{( r - 1 ) {k}_{0}} {\sum }_{n = 0}^{( N / r ) - 1} {x}_{( rn + ( r - 1 ) )} {w}_{N / r}^{{nk}_{0}}\end{matrix} ] = col [ {\sum }_{n = 0}^{( N / r ) - 1} {x}_{( rn + {j}_{0} )} {w}_{N / r}^{{nk}_{0}} ] ; \qquad ( Equation 30 )$$

for j₀=0, . . . , (r−1), k₀=0, 1, . . . , (N/r)−1 and [w_{N}^{j}^{k}^{₀}]=diag(w_{N}⁰, w_{N}^{k}^{₀}, . . . , w_{N}^{(r-1)k}^{₀}). For the second factorization, Equation (23) is factored as follow:

$${X}_{( k )} = {{*}^{⋒}}_{( r , r , N / r )} ( {T}_{r} \times [ {w}_{N}^{{j}_{0} {k}_{0}} ] , [ \begin{matrix}{{*}^{⋒}}_{( r , {r}^{2} , N / {r}^{2} )} ( {T}_{r} , [ \begin{matrix}{\sum }_{n = 0}^{( \frac{N}{{r}^{2}} ) - 1} {x}_{r ( rn )} {w}_{N / {r}^{2}}^{{nk}_{1}} \\ ⋮ \\ {w}_{N}^{r ( r - 1 ) {k}_{1}} {\sum }_{n = 0}^{( \frac{N}{{r}^{2}} ) - 1} {x}_{( r ( rn + ( r - 1 ) ) )} {w}_{N / {r}^{2}}^{{nk}_{1}}\end{matrix} ] ) \\ {{*}^{⋒}}_{( r , {r}^{2} , N / {r}^{2} )} ( {T}_{r} , [ \begin{matrix}{\sum }_{n = 0}^{( \frac{N}{{r}^{2}} ) - 1} {x}_{r ( rn ) + 1} {w}_{N / r}^{{nk}_{1}} {r}^{2} \\ ⋮ \\ {w}_{N}^{r ( r - 1 ) {k}_{1}} {\sum }_{n = 0}^{( \frac{N}{{r}^{2}} ) - 1} {x}_{( r ( rn + ( r - 1 ) + 1 )} {w}_{N / {r}^{2}}^{{nk}_{1}}\end{matrix} ] ) \\ ⋮ \\ {{*}^{⋒}}_{( r , {r}^{2} , N / {r}^{2} )} ( {T}_{r} , [ \begin{matrix}{\sum }_{n = 0}^{( \frac{N}{{r}^{2}} ) - 1} {x}_{r ( rn ) + ( r - 1 )} {w}_{N / {r}^{2}}^{{nk}_{1}} \\ ⋮ \\ {w}_{N}^{r ( r - 1 ) {k}_{1}} {\sum }_{n = 0}^{( \frac{N}{{r}^{2}} ) - 1} {x}_{( r ( rn + ( r - 1 ) ) + ( r - 1 ) )} {w}_{N / {r}^{2}}^{{nk}_{1}}\end{matrix} ] )\end{matrix} ] ) ; \qquad ( Equation 31 )$$

which could be simplified as:

$${X}_{( k )} = {{*}^{⋒}}_{( r , r , N / r )} ( {T}_{r} \times [ {w}_{N}^{{j}_{0} {k}_{0}} ] , col [ {{*}^{⋒}}_{( r , {r}^{2} , N / {r}^{2} )} ( {T}_{r} \times [ {w}_{N}^{{rj}_{1} {k}_{1}} ] , col [ {\sum }_{n = 0}^{{k}_{1} - 1} {x}_{( {r}^{2} n + {rj}_{1} + {j}_{0} )} {w}_{N / {r}^{2}}^{{nk}_{1}} ] ) ] ) ; \qquad ( Equation 32 )$$

for j₀=j₁=0, . . . , (r−1), k₁=0, 1, . . . , (N/r²)-1 [w_{N}^{j}^{₀}^{k}^{₀}]=diag(w_{N}⁰, w_{N}^{k}^{₀}, . . . ,

$${w}_{N}^{( r - 1 ) {k}_{0}} ) and [ {w}_{N}^{{rj}_{1} {k}_{1}} ] = diag ( {w}_{N}^{0} , {w}_{N}^{{rk}_{1}} , … , {w}_{N}^{r ( r - 1 ) {k}_{1}} ) .$$

If the factorization process continues until r⁽ⁱ⁾ transform of size r is obtained, then equation (1) is expressed as:

$${X}_{( k )} {{=}^{\hat{*}}}_{{( r , {r}^{i} , {k}_{i} )}_{i = 0}}^{( {log}_{r} N ) - 2} ( {T}_{r} \times [ {w}_{N}^{{r}^{( i )} {j}_{i} {k}_{i}} ] , col [ {\sum }_{n = 0}^{{k}_{i} - 1} {x}_{( {r}^{( i + 1 )} n + {r}^{( i )} {j}_{( i )} + … + {j}_{0} )} {w}_{N / {r}^{i + 1}}^{{nk}_{i}} ] ) ; \qquad ( Equation 33 )$$

for j₀=j₁= . . . =jᵢ=0, . . . , (r−1), kᵢ32 0, 1, . . . , (N/r⁽ⁱ⁺¹⁾)=−1 and

$$[ {w}_{N}^{{r}^{( i )} {j}_{i} {k}_{i}} ] = diag ( {w}_{N}^{0} , {w}_{N}^{{r}^{( i )} {k}_{i}} , … , {w}_{N}^{{r}^{( i )}} ( r - 1 ) {k}_{i} ) .$$

In DSP layman's language, the factorization of an FFT can be interpreted as dataflow diagram (or Signal Flow Graph), which depicts the arithmetic operations and their dependencies. If the dataflow diagram is read from left to right, the decimation in frequency algorithm is obtained where A in equation (22) is equal to r⁽⁻¹⁾. Alternatively, if the dataflow diagram is read from right to left, the decimation in time algorithm is obtained where λ in equation (22) is equal to r.

Equation (30) is developed according to Jaber product. Knowing that:

$${T}_{r} = [ \begin{matrix}{w}^{0} & {w}^{0} & {w}^{0} & – & {w}^{0} \\ {w}^{0} & {w}^{N / r} & {w}^{2 N / r} & – & {w}^{( r - 1 ) N / r} \\ {w}^{0} & {w}^{2 N / r} & {w}^{4 N / r} & – & {w}^{2 ( r - 1 ) N / r} \\ – & – & – & – & – \\ {w}^{0} & {w}^{( r - 1 ) N / r} & & – & {w}^{{( r - 1 )}^{2} N / r}\end{matrix} ] = [ {T}_{( l , m )} ] ; \qquad ( Equation 34 )$$

where:

$${T}_{( l , m )} = {w}^{( ( lm \frac{N}{r} ) ) N} ; \qquad ( Equation 35 )$$

and l=m=0, . . . , r−1 and ((x))_{N=x} modulo N, therefore, equation (30) can be simplified as:

$${X}_{{l}_{( k )}} = {\sum }_{j0 = 0}^{r - 1} … {\sum }_{{j}_{i} = 0}^{r - 1} {\sum }_{n = 0}^{r - 1} {x}_{( {r}^{( i + 1 )} n + {r}^{( i )} {j}_{( i )} + … + {j}_{0} )} {w}_{N}^{{( ( l \times ( \frac{N}{r} ) \times J + ( J + n \times ( \frac{N}{r} ) ) \times k ) )}_{N}} ; \qquad ( Equation 36 )$$

where j=r⁽ⁱ⁾jᵢ+r⁽ⁱ⁻¹⁾j₍ᵢ₋₁₎+ . . . +j₀ and for j₀=j₁= . . . =jᵢ=0, . . . , (r−1), l=0, 1, . . . , (r−1), k=0, 1, . . . , (N/r)−1, i=(logᵣ N)−1 and the l^{th} output of X₍ₖ₎ is stored at the address memory location given by:

$${X}_{{l}_{( k )}} = l \times ( \frac{N}{r} ) + k . \qquad ( Equation 37 )$$

The present invention uses notations as follows:

$${x}_{( n , {j}_{( i )} , … , {j}_{0} )} = {x}_{( {r}^{( i + 1 )} n + {r}^{( i )} {j}_{( i )} + … + {j}_{0} )} and B ( l , n , {j}_{i} … , {j}_{0} , k ) = {w}_{N}^{{( ( l \times ( \frac{N}{r} ) \times J + ( J + n \times ( \frac{N}{r} ) ) \times k ) )}_{N}} .$$

FIG. 5 is a radix-r one iteration kernel computation engine 100 for performing an N-point FFT in accordance with the present invention. The radix-r one iteration engine 100 comprises r multipliers 102₀-102ᵣ₋₁ implemented in parallel and one accumulator 104. The engine 100 receives r data inputs at a time, N/r times in series and each data input is multiplied with corresponding coefficients by each multiplier 102₀-102ᵣ₋₁ and the multiplication results are accumulated over N/r times by the accumulator 104. The accumulator 104 output corresponds to one of the N FFT outputs. FIG. 6 is an alternative representation of the engine 100.

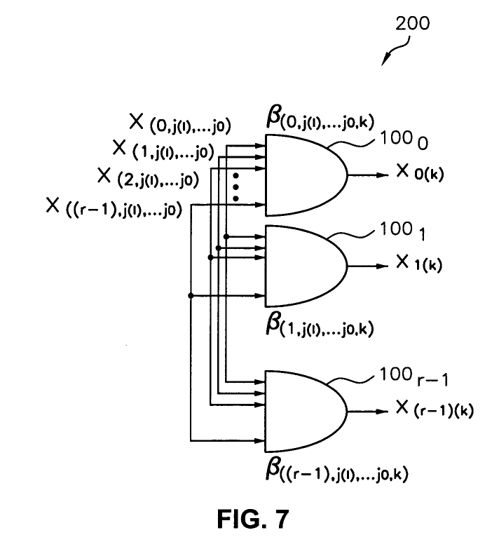

FIG. 7 is a radix-r one iteration module 200 in accordance with the present invention. One radix-r one iteration module 200 comprises r one iteration kernel computation engines 100₀-100ᵣ₋₁, Each module 200 generates r FFT outputs. In order to generate N outputs N/r modules 200 are implemented in parallel.

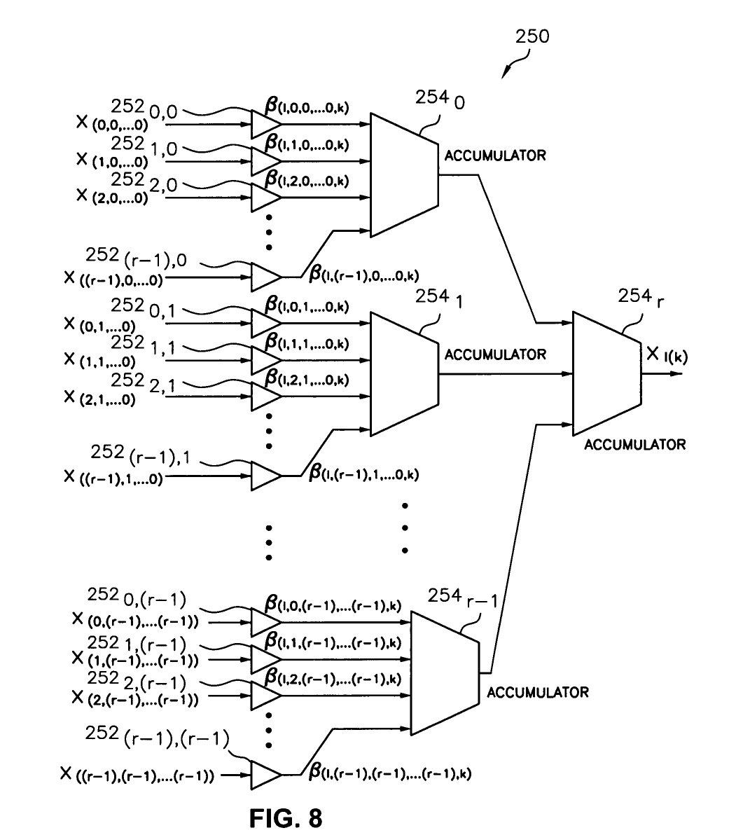

FIG. 8 shows a radix-r one iteration engine 250 in which the degree of parallelism is increased. The engine 250 comprises a plurality of, (up to r²), multipliers 252_{0,0}-252_{(r-1),(r-1)} implemented in parallel and one or more accumulators 254₀₋ᵣ. r or more data inputs enter the engine 250 and multiplication operations are performed simultaneously by the multipliers 252_{0,0}-252_{(r-1),(r-1)}. If r² multipliers 252_{0,0}-252_{(r-1),(r-1)} are utilized, only one step of multiplication operation is necessary.

The present invention provides the ability to divide a process into serial and parallel portions (or pure parallel portions) where the parallel portions are executed concurrently. By doing so, the efficiency increases drastically. In fact:

$$\begin{matrix}Speed up = \frac{Serial Time}{Parallel Time} ; & ( Equation 38 ) \\ = \frac{1}{( 1 - α ) + \frac{α}{n}} ; & ( Equation 39 )\end{matrix}$$

where α=fraction of work that can be done in parallel and n=the number of processors (or multipliers).

The efficiency or the overall performance of the system is given by:

$$Efficiency = \frac{Speedup}{Processors} \times 100 \qquad ( Equation 40 )$$

Analytical modeling of the parallel speed up is computed by running the parallel fraction α over n processors (or multipliers) and the part that must be executed in serial gets no increase in speed. Therefore, the overall performance is limited by the fraction of work that cannot be done in parallel (1−α). Diminishing returns with increasing n and astonishing returns is achieved in a pure parallel system (i.e. 1−α=0). Assuming serial times consumes 10 time units and the parallel time consumes 4 time units, therefore:

$$Speedup = \frac{10}{4} = 2.5 ;$$

$$and \text{:}$$

$$Efficiency = \frac{2.5}{4} \times 100 = 62.5 \%$$

Multiplier implementation is not a major concern considering the current technology as summarized in Table 1.

TABLE 1

| Multiplier | Technology | Area | Density |
|---|---|---|---|
| 1998 | .25 micron | .05 mm² | 2000 per chip |
| 2000 | .18 micron | .02 mm² | 4000 per chip |
| 2002 | .13 micron | .01 mm² | 8000 per chip |

For example, in the implementation of a 50 mm², 0.25 micron chip using adders, registers and multipliers, 2000 adders/registers and 200 multipliers may be implemented in less than ½ of the chip. It is true that the adders and registers are about 10 times smaller and 10 times lower energy, but this is compensated by reducing the memory size into ½. The reduced space known as the sink memory in which the processed data is held for further processing in the other stage is completely eliminated, and by doing so, the size of the chip and its power consumption is drastically reduced.

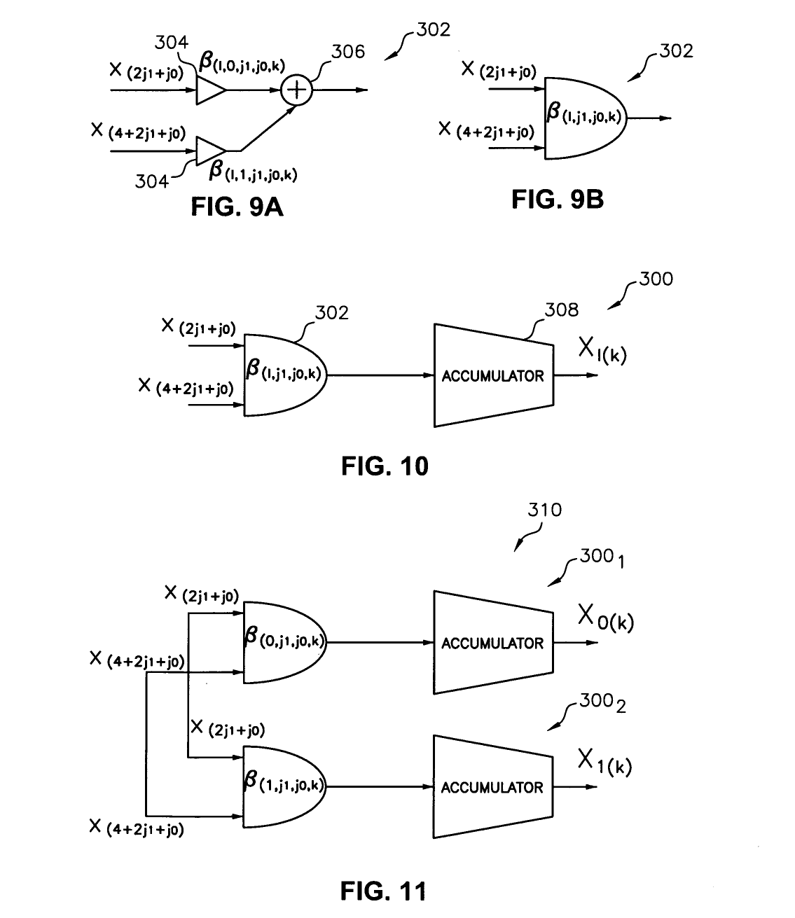

As an example, 8 point FFT with radix-2 one iteration FFT module is explained hereinafter. FIGS. 9(a) and 9(b) show a basic radix-2 one iteration FFT engine core 302 and an alternative representation of the same, respectively, in accordance with the present invention. Each radix-2 one iteration FFT engine core 302 comprises two multipliers 304 and one adder 306. Each output of an 8-point FFT process costs (time wise) one multiplication and one addition. Assuming that performing an n bit multiplication is equivalent to n−1 additions, each output costs 4n additions per output. The whole process for 8-point FFT process therefore costs 32n additions. FIG. 10 shows hardware implementation of the radix-2 one iteration FFT engine 300 in a single processor environment. The engine 300 comprises an engine core 302 and an accumulator 308.

FIG. 11 is a radix-2 one iteration FFT module 310 in accordance with the present invention. Two engines 300₁, 300₂, as shown in FIG. 10, comprise one module 310 in radix-2 case. Data inputs x(0), x(4), x(1), x(5), x(2), x(6), x(3), x(7), two by two, enter each engine 300₁, 300₂ in series and FFT computation is performed in series. Each output is provided by four multiplications. By doing so the memory usage is cut by half and the amount of memory accesses (storage) is reduced. This is extremely beneficial since memory accesses are very costly in terms of time.

The same process can be executed in 16n additions if it is executed on two parallel processors as shown in FIG. 11. Therefore the speed up would be:
Speed Up=64÷32=2;
and the efficiency, which is measure of effectiveness of processor utilization, would be:
Efficiency=(2÷2)×100=100%;
and the cost would be:
Cost=(Serial Time×Number of processor)/Speed Up=(64×2)/2=64.

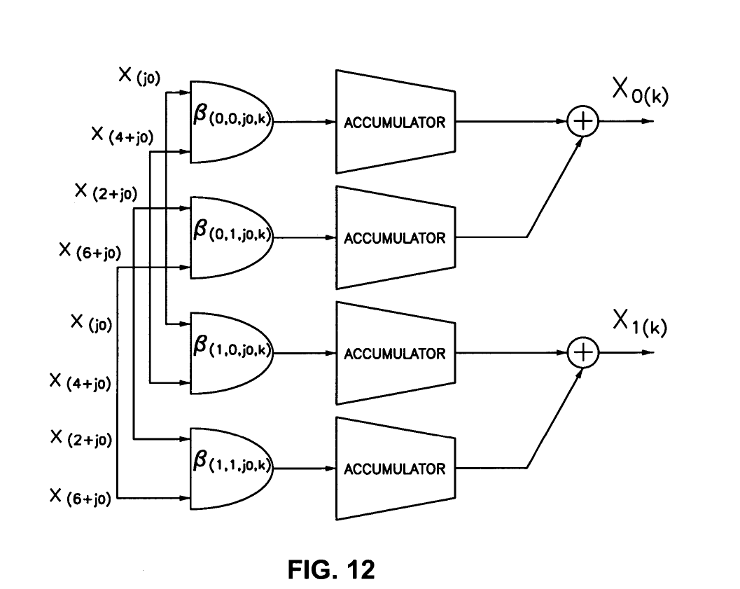

The degree of parallelism could be increased by utilizing more processors such as shown in FIG. 12. Two modules are utilized in parallel to generate one FFT output, therefore the speedup would be:
Speed Up=64÷16=4;
and the efficiency would be:
Efficiency=(4÷4)×100=100%;
and the cost would be:
(64×4)/4=64.

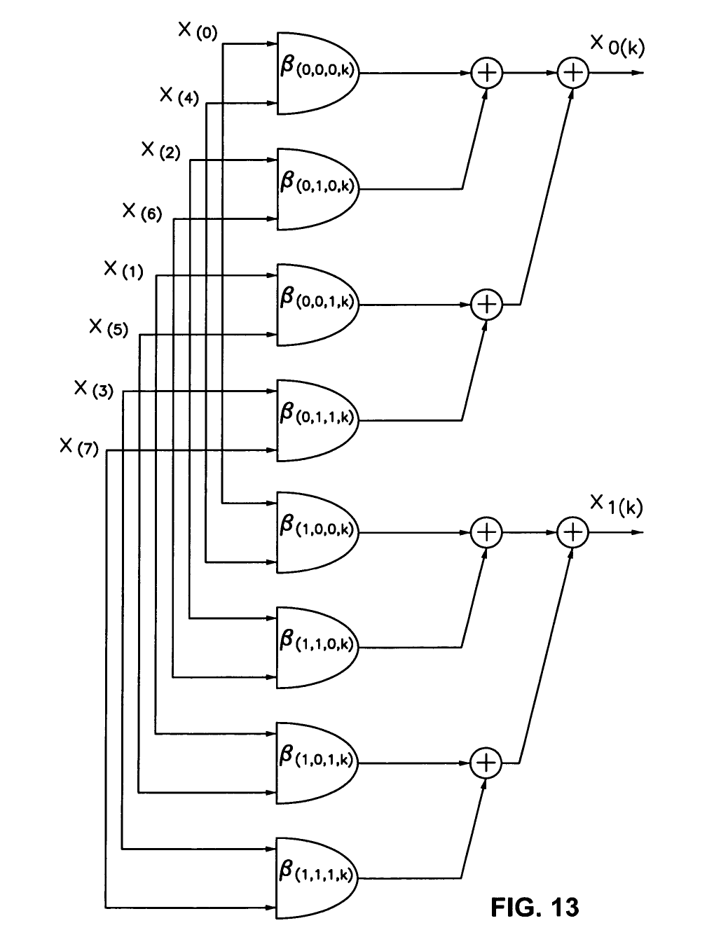

The maximum degree of parallelism could be achieved when the number of parallel processors is equal to N, (the data size, in this example 8) as shown in FIG. 13. In this case speedup would be:
Speed Up=64÷8=8;
and the efficiency would be:
Efficiency=(8÷8)×100=100%;
and the cost would be:
(64×8)18=64.

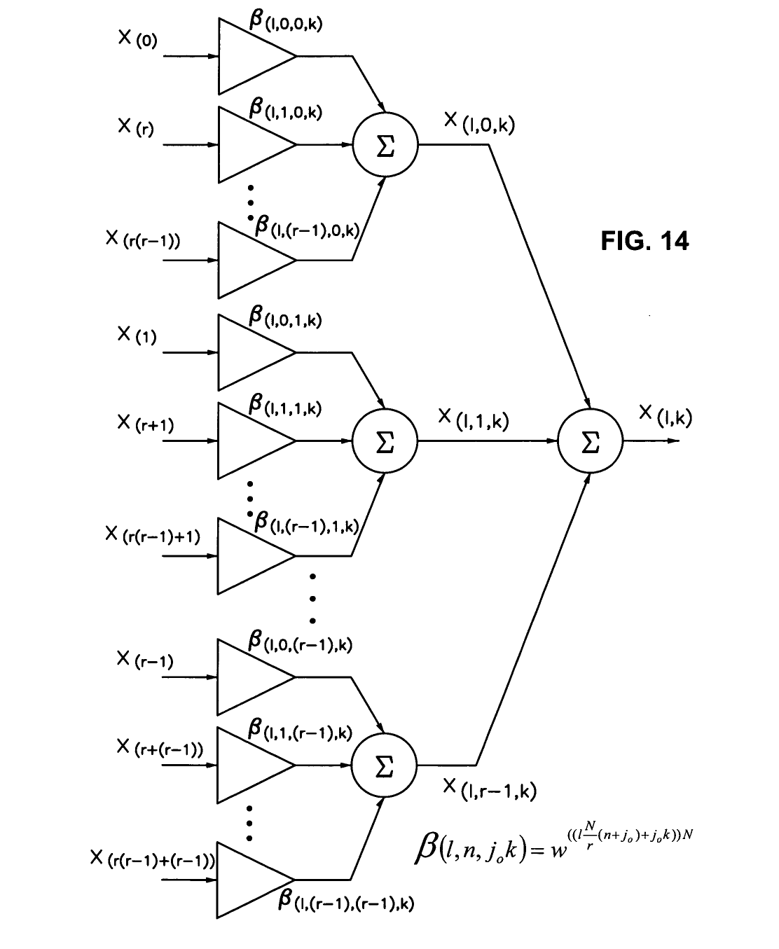

The present invention provides the ability to divide a process into serial and parallel portions, where the serial portions are executed concurrently in parallel. In addition, the key issues of parallel computing are well respected such as load balancing where the same amount of work has been associated for every processor. FIG. 13 shows locality where communication among the processors have been minimized or eliminated, the scalability where the capability of solving large problem efficiently has been proven, (i.e., efficiency of 1 is the best 100%), and the ideal speed up on N processors is achieved which is equal to N. By doing so the efficiency will increase drastically. FIG. 14 is a diagram of radix-r case utilizing r² multipliers in parallel for speed up.

Analytical modeling of the parallel speed up is computed by running the parallel fraction α over n processors (or multipliers) and the part that must be executed in serial gets no speed up. Therefore, the overall performance is limited by the fraction of work that cannot be done in parallel (1−α). Diminishing returns with increasing n and astonishing returns is achieved in a pure parallel system (i.e. 1−α=0).

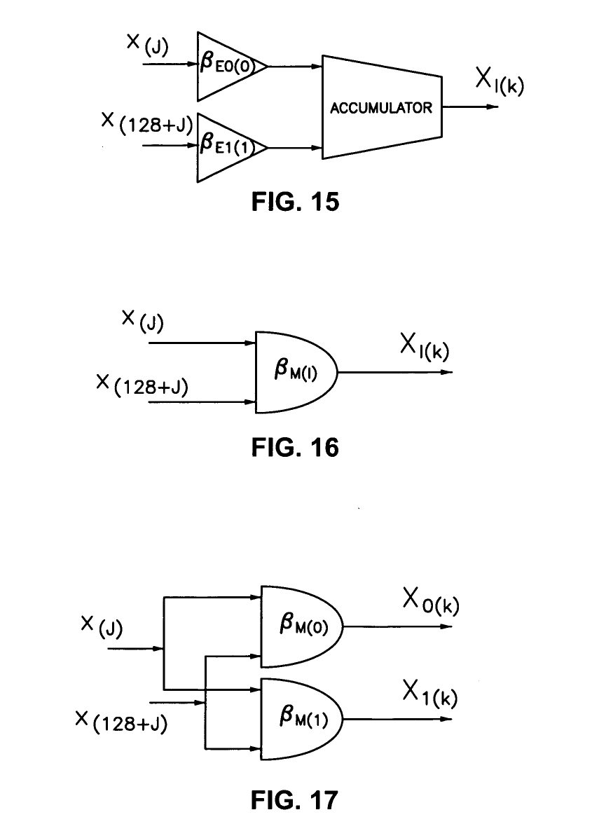

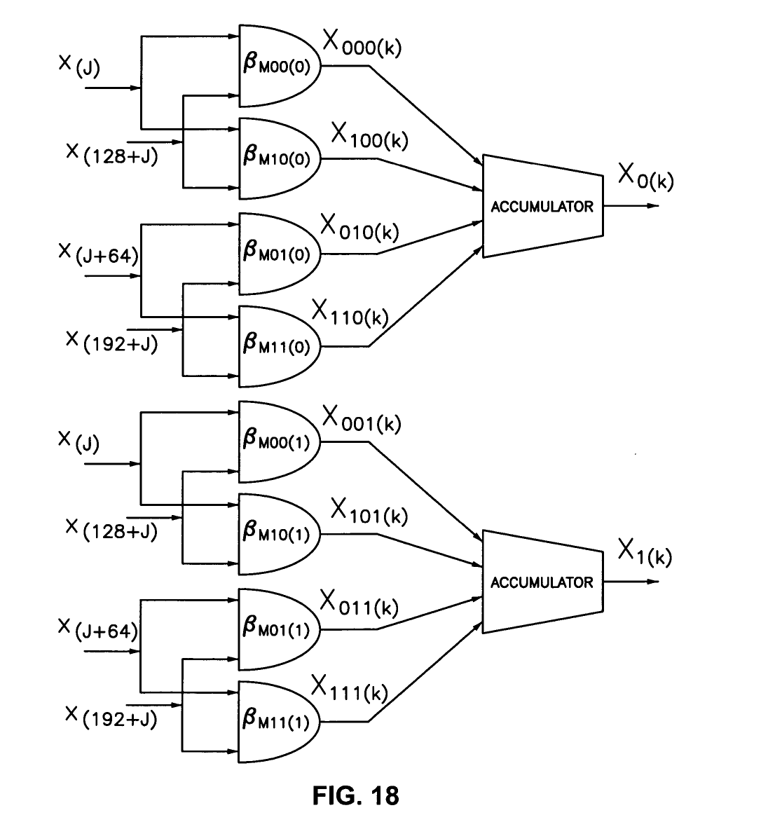

As another example, a radix-2 one iteration FFT for 256-point FFT is explained hereinafter. The radix-2 one iteration FFT engine is shown in FIG. 15, wherein:

$$\begin{matrix}{β}_{E 0 ( 0 )} = {w}_{N}^{{( ( l \times ( \frac{N}{2} ) \times J + J \times k ) )}_{N}} ; and & ( Equation 41 ) \\ {β}_{E 1 ( 1 )} = {w}_{N}^{{( ( l \times ( \frac{N}{2} ) \times J + ( J + ( \frac{N}{2} ) ) \times k ) )}_{N}} ; & ( Equation 42 )\end{matrix}$$

in which such type of engine could be implemented in a digital signal processor (DSP) core processor. There is no need of memory usage to store the intermediate result.

For a data size of 256, the mathematical representation of the radix-r one iteration FFT engine:

$${X}_{{l}_{( k )}} = {\sum }_{j 0 = 0}^{r - 1} ⋯ {\sum }_{{j}_{i} = 0}^{r - 1} {\sum }_{n = 0}^{r - 1} {x}_{( {r}^{( i + 1 )} n + {r}^{( i )} {j}_{( i )} + … + {j}_{0} )} {w}_{N}^{{( ( l \times ( \frac{N}{r} ) \times J + ( J + n \times ( \frac{N}{r} ) ) \times k ) )}_{N}} ; \qquad ( Equation 43 )$$

where j=r⁽ⁱ⁾jᵢ₊ᵣ⁽ⁱ⁻¹⁾j₍ᵢ₋₁₎+ . . . +j₀ and for j₀=j₁= . . . =jᵢ=0, . . . ,(r−1),l =0, 1, . . . , (r−1), k=0, 1, . . . , (N/r)−1, i=(logᵣN)−1; can be represented as:

$${X}_{( k )} = {\sum }_{{j}_{0} = 0}^{1} {\sum }_{{j}_{1} = 0}^{1} {\sum }_{{j}_{2} = 0}^{1} {\sum }_{{j}_{3} = 0}^{1} {\sum }_{{j}_{4} = 0}^{1} {\sum }_{{j}_{5} = 0}^{1} {\sum }_{{j}_{6} = 0}^{1} {\sum }_{n = 0}^{1} ( {2}^{7} n + J ) \times {w}_{N}^{{( ( l \times ( \frac{N}{2} ) \times J + ( J + n \times ( \frac{N}{2} ) ) \times k ) )}_{N}} ; \qquad ( Equation 44 )$$

where J=2⁶j₆+2⁵j₅+2⁴j₄+2³j₃+2²j₂+2jᵢ+j₀ and for l=0, 1, . . . , (r−1), k=0, 1, . . . , (N/r)−1.

FIG. 16 represents an alternative representation of the radix-2 one iteration FFT engine that could be used in parallel to form a radix-2 FFT module in FIG. 17, that could be further used to produce two outputs for each set of inputs. Each couple of the coefficients multipliers provided to the radix-2 FFT module is provided by:

$$\begin{matrix}{β}_{M ( 0 )} = [ \begin{matrix}{β}_{E 0 ( 0 )} = {w}_{N}^{{( ( J \times k ) )}_{N}} \\ {β}_{E 1 ( 1 )} = {w}_{N}^{{( ( ( J + ( \frac{N}{2} ) ) \times k ) )}_{N}}\end{matrix} ] ; & ( Equation 45 ) \\ {β}_{M ( 1 )} = [ \begin{matrix}{β}_{E 0 ( 0 )} = {w}_{N}^{{( ( ( \frac{N}{2} ) \times J + J \times k ) )}_{N}} \\ {β}_{E 1 ( 1 )} = {w}_{N}^{{( ( ( \frac{N}{2} ) \times J + ( J + ( \frac{N}{2} ) ) \times k ) )}_{N}}\end{matrix} ] . & ( Equation 46 )\end{matrix}$$

As stated before, the degree of parallelism could be increased in order to speed up the process and this can be easily achieved by duplicating the structure of the radix-2 FFT one iteration core module and by adding r accumulator in each stage. In this case, Equation 44 can be expressed as:

$${X}_{( k )} = {\sum }_{{j}_{0} = 0}^{1} {\sum }_{{j}_{1} = 0}^{1} {\sum }_{{j}_{2} = 0}^{1} {\sum }_{{j}_{3} = 0}^{1} {\sum }_{{j}_{4} = 0}^{1} {\sum }_{{j}_{5} = 0}^{1} {\sum }_{{j}_{6} = 0}^{1} {\sum }_{n = 0}^{1} ( {2}^{7} n + {2}^{6} {J}_{6} + J ) \times {w}_{N}^{{( ( l \times ( \frac{N}{2} ) \times ( J + {2}^{6} {J}_{6} ) + ( ( J + {2}^{6} {J}_{6} ) + n \times ( \frac{N}{2} ) ) \times k ) )}_{N}} ; \qquad ( Equation 47 )$$

where J=2⁵j₅+2⁴j₄+2³j₃+2²j₂+2j₁+j₀ and for l=0, 1, . . . , (r−1), k=0, 1, . . . , (N/r)−1. Where the value of β_{Mnj}_{₆}₍ₗ₎ is obtained by replacing n, j₆, l with their respective value.

This structure is attractive to parallel computing and massively parallel computing machines on which higher performance and maximum speed up is achieved with the minimum of multipliers implementation when the number of the implemented multipliers is equal to N for a specific radix-r<N. In fact, the radix-256 engine which contains 256 multipliers (straightforward DFT) produces one output and the one iteration FFT kernel module requires 256×256=65536 multipliers.

With the radix-16 case one iteration FFT core engine, each sixteen inputs to the one iteration radix-16 butterfly core engine with the parallel implementation of sixteen multipliers require sixteen multiplications to produce one output. Therefore, the multiplication cost will be 16×256=4,096. During this process, there is no need to hold the intermediate result for further processing. Instead, it is sent to an accumulator in order to produce the desired output. By doing so, a huge reduction in the execution time is obtained by eliminating the access and storing times and by eliminating the usage of extra memory to store the intermediate data and by reducing the complexity of the control engine.

An access time is the average period of time it takes for a random access memory (RAM) to complete one access and begin another. The access time comprises a latency, (the time it takes to initiate a request for data and prepare to access it), and a transfer time. DRAM chips for personal computers have accessing times of 50 to 150 nanoseconds. A static RAM (SRAM) has access times as low as 10 nanoseconds. Ideally, the accessing time of the memory should be fast enough to keep up with the CPU. If not, the CPU will waste a certain number of clock cycles, which makes it slower.

Radix-16 case one Iteration JFFT core (Single JFFT Engine):

Knowing that for each sixteen inputs to the one iteration radix-16 butterfly core engine with the parallel implementation of 256 multipliers will require one multiplication to produce sixteen outputs the multiplication cost will be 16. During this process there is no need to hold the intermediate result for further processing; instead it will be sent to an accumulator in order to produce the desired output. By doing so, a huge reduction in the execution time is obtained by eliminating the access and storing times and by eliminating the usage of extra memory to store the intermediate data and by reducing the complexity of the control engine. The radix-16 engine contains 16 multipliers interconnected each other in order to provide one output. A 256-point FFT can be computed on a single radix-16 FFT engine which will provide one output without passing through intermediate result; hence the name “one iteration FFT”. This process can be speeded up by implementing those 16 radix engines in parallel in order to obtain the result in 256 cycles.

Although the features and elements of the present invention are described in the preferred embodiments in particular combinations, each feature or element can be used alone without the other features and elements of the preferred embodiments or in various combinations with or without other features and elements of the present invention.

1. A Fourier transform processor for performing a Fourier transform of N data inputs into N data outputs with a radix-r butterfly, the Fourier transform processor comprising:
N/r radix-r modules, each radix-r module comprising:
a plurality of radix-r engines, each radix-r engine comprising a plurality of multipliers for multiplying each of the data inputs and corresponding coefficients, an adder for adding the multiplication results and an accumulator for accumulating the multiplication results to generate one Fourier transform output.

2. The Fourier transform processor of claim 1 wherein one radix-r engine generates one output.

3. The Fourier transform processor of claim 1 wherein at least two radix-r engines are utilized in parallel to generate one output.

4. The Fourier transform processor of claim 1 wherein the coefficients are derived from the product of an adder matrix and a twiddle factor matrix.

5. The Fourier transform processor of claim 1 wherein the l^{th} output of X₍ₖ₎ is stored at the address memory location given by:
$${X}_{{l}_{( k )}} = l \times ( \frac{N}{r} ) + k ,$$
wherein k=0, 1, . . . , (N/r)−1.

6. A Fourier transform processor for performing a Fourier transform of N data inputs into N data outputs with a radix-r butterfly, the Fourier transform processor comprising:
N/r radix-r modules, each radix-r module comprising:
N radix-r engines, each radix-r engine comprising a plurality of multipliers for multiplying each of the data inputs and corresponding coefficients, an adder for adding the multiplication results; and
a plurality of adders for adding outputs of the radix-r engines utilized in parallel to generate one Fourier transform output.

7. The Fourier transform processor of claim 6 wherein the coefficients are derived from the product of an adder matrix and a twiddle factor matrix.

8. The Fourier transform processor of claim 6 wherein the l^{th} output of X₍ₖ₎ is stored at the address memory location given by:
$${X}_{{l}_{( k )}} = l \times ( \frac{N}{r} ) + k ,$$
wherein k=0, 1, . . . , (N/r)−1.
